(19) United States
(12) Patent Application Publication
(10) Pub. No.: US 2013/0151550 A1
(43) Pub. Date: Jun. 13, 2013

(54) ELECTRONIC DEVICE AND RECIPE SELECTING METHOD THEREOF

(71) Applicant: CHENG-HUANG LU, Shenzhen City (CN)

(72) Inventor: CHENG-HUANG LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/339,377

(22) Filed: Dec. 29, 2011

(30) Foreign Application Priority Data
Dec. 13, 2011 (CN) 201110414881.8

(51) Int. Cl. G06F 17/30

(52) U.S. Cl. 707/769; 707/705; 707/E17.014

(57) ABSTRACT

The disclosure provides an electronic device and a method of selecting recipes from cookbooks. The device includes a storage unit, a processing unit, and a display unit. The storage unit is for storing a plurality of electronic cookbooks and each cookbook is marked with a timestamp by way of a classification and includes a recipe. The processing unit is for acquiring current date and/or time, determining suitable cookbooks from the storage unit according to the timestamp of each cookbook and the current date and/or time and acquires recipes from the suitable cookbooks. The display unit is for displaying the retrieved content from the cookbooks.

### BACKGROUND

1. Technical Field

The present disclosure relates to electronic devices and, particularly, to an electronic device with a function of selecting menus and recipes from cookbooks, and a method of selecting a recipe from cookbooks implemented by the electronic device.

2. Description of Related Art

Hard-copy cookbooks can be bought in the market and many electronic cookbooks are available on the Internet. However, before a person cooks, she often takes account of the time of year (the season) and the times of day for different meals, and the tastes of those who will enjoy her cooking. If she goes to a shop to search for suitable recipes, she has to search a large number of cookbooks to obtain adaptable cookbooks and spend a lot of money for a number of cookbooks to cover all possible variations and ranges of meals, and if she goes to the web to search, she will waste a lot of time.

Therefore, it is necessary to provide an electronic device and a method capable of overcoming the limitations described.

### BRIEF DESCRIPTION OF THE DRAWINGS

FIG. 1 is a block diagram of an electronic device, according to an exemplary embodiment.

FIG. 2 is a block diagram of a processing unit of the electronic device of FIG. 1.

FIG. 3 is a table stored in the electronic device of FIG. 1.

FIG. 4 is a first schematic view of a cookbook query interface of the electronic device of FIG. 1.

FIG. 5 is a second schematic view of the interface of FIG. 4 of the electronic device of FIG. 1.

FIG. 6 is a third schematic view of the interface of FIG. 4 of the electronic device of FIG. 1.

FIG. 7 is a fourth schematic view of the interface of FIG. 4 of the electronic device of FIG. 1.

FIG. 8 is a flowchart of a method of selecting a recipe from cookbooks, according to an exemplary embodiment.

### DETAILED DESCRIPTION

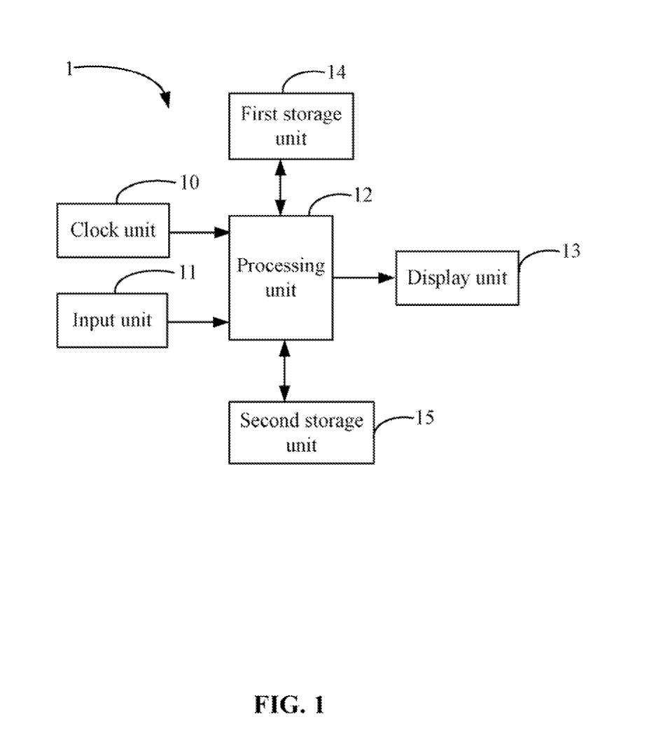

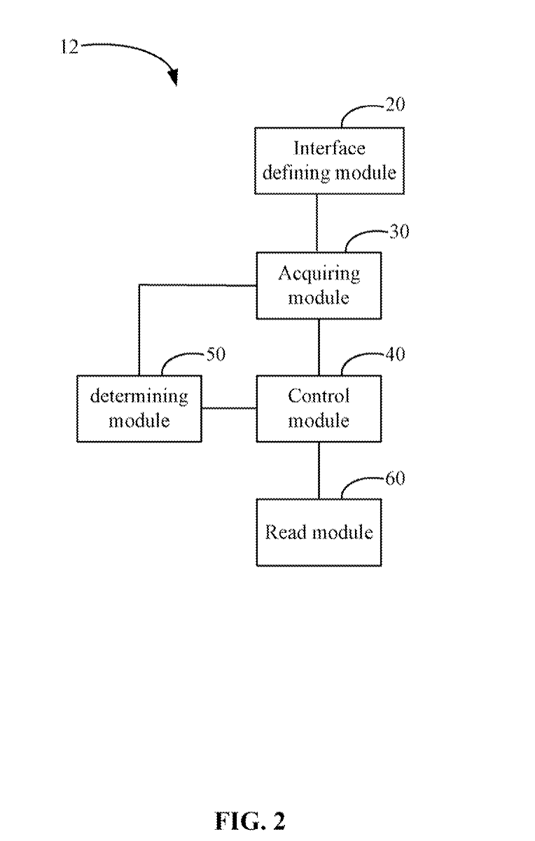

FIG. 1 is a block diagram of an electronic device, according to an exemplary embodiment. The electronic device 1, such as a mobile phone or a PDA, is portable and may be carried by a user. The electronic device 1 includes a clock unit 10, an input unit 11, a processing unit 12, a display unit 13, a first storage unit 14, and a second storage unit 15. The clock unit 10 measures current time and date. The input unit 11 generates input signals in response to user inputs from a user. The display unit 13 displays information. The processing unit 12 controls the electronic device 1. As shown in FIG. 2, the processing unit 12 includes an interface defining module 20, an acquiring module 30, a control module 40, a determining module 50, and a read module 60.

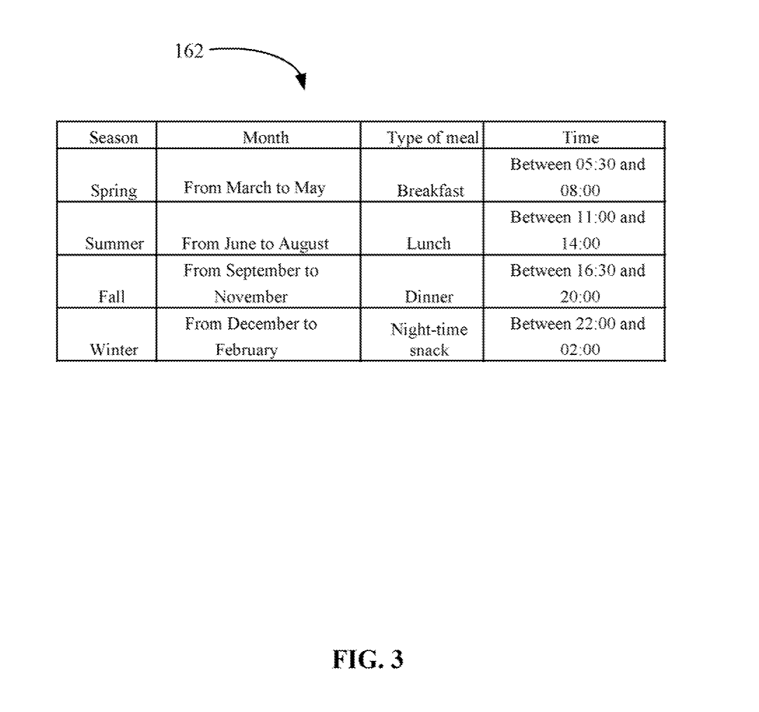

FIG. 3 is a table stored in the electronic device of FIG. 1. The first storage unit 14 stores the table 162 which records appropriate relationships between seasons, months, types of meal, and times of day. The table 162 includes a season column, a month column, a type of meal column, and a time of day column.

The season column records the four seasons. Each season is assigned a first time period. The month column records the first time period associated with each season. For example, spring is from March to May, summer is from June to August, fall is from September to November, and winter is from December to February.

The type of meal column records four meals, such as breakfast, lunch, dinner, and supper or night-time snack. Each meal is assigned a second time period. The time column records the second time period associated with each type of meal. For example, breakfast is arranged between 05:30 and 08:00, lunch is arranged between 11:00 and 14:00, dinner is arranged between 16:30 and 20:00, and the night-time snack is arranged between 22:00 and 02:00. The second time period may be defined by a user of the electronic device 1. In another embodiment, the table 162 is divided into two tables which record relationships among seasons, months, types of meal, and times.

The second storage unit 15 stores an electronic cookbook database which includes a number of cookbooks. Each cookbook includes a title, usable ingredients, an instruction concerning nutritional components, and a recipe. The title of each cookbook records a timestamp which denotes an appropriate season or appropriateness for several seasons and/or a suitable type or suitability for several types of meals. For example, the title of one cookbook is about green bean soup and the timestamp of the cookbook is marked for summer time. In another embodiment, the timestamp of each cookbook is recorded in the cookbook, that is, the cookbook itself further includes the timestamp.

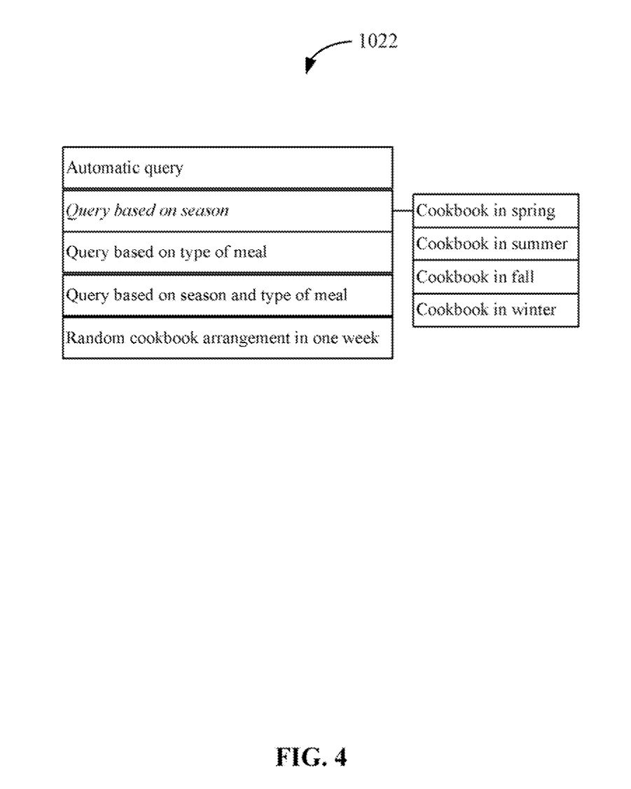

The interface defining module 20 defines a cookbook query interface, such as the interface 1022 in FIGS. 4-7. The cookbook query interface 1022 includes a first constant menu which defines a number of cookbook query items. In the embodiment, the first menu includes five types of cookbook query items, such as automatic query, query based on season, query based on type of meal, query based on season and type of meal, and random cookbook arrangement in one week. The user can select one type of the cookbook query items in the first menu according to the user's needs. When the item of automatic query is selected, the processing unit 12 acquires cookbooks and recipes from the acquired cookbooks according to the current date and time as in the following description.

Referring to FIG. 4, the item of query based on season corresponds to a first sub-menu which, when it appears, includes four sub-items, such as cookbook in spring, cookbook in summer, cookbook in fall, and cookbook in winter. Each of the four sub-items corresponds to one or more cookbooks.

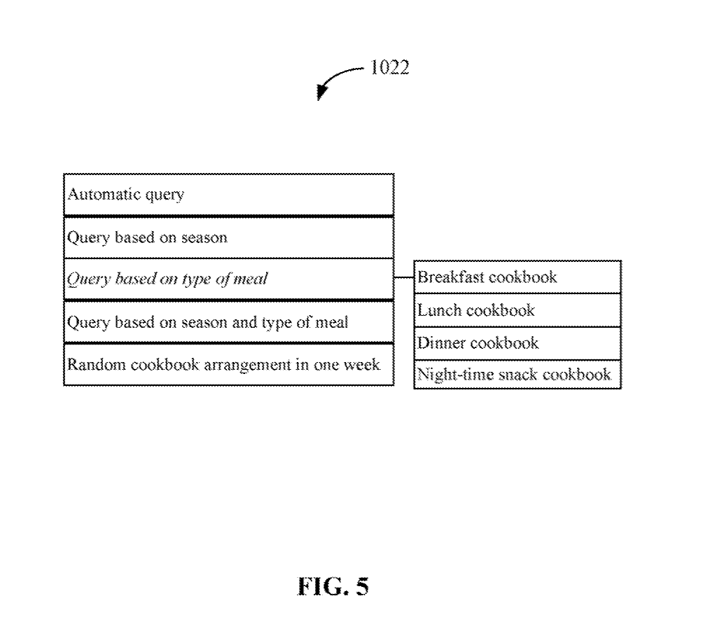

Referring to FIG. 5, the item of query based on type of meal corresponds to a second sub-menu which includes four sub-items, such as breakfast cookbook, lunch cookbook, dinner cookbook, and night-time snack cookbook. Each of the four sub-items corresponds to one or more cookbooks.

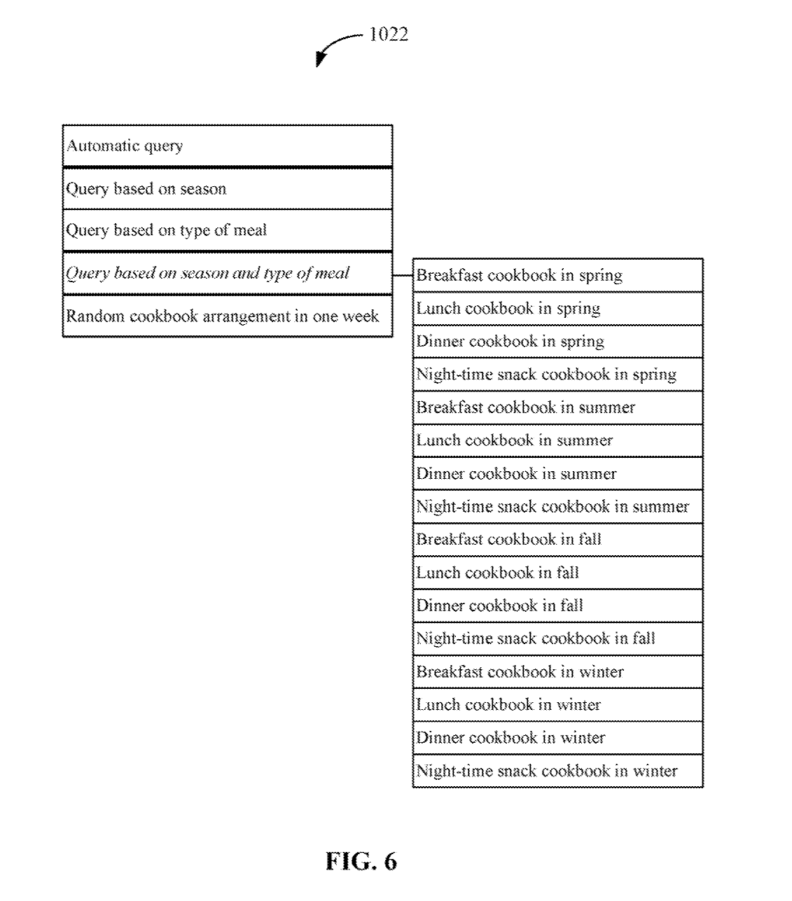

Referring to FIG. 6, the item of query based on season and type of meal corresponds to a third sub-menu which includes sixteen sub-items, such as breakfast cookbook in spring, lunch cookbook in spring, dinner cookbook in spring, night-time snack cookbook in spring, breakfast cookbook in summer, lunch cookbook in summer, dinner cookbook in summer, night-time snack cookbook in summer, breakfast cookbook in fall, lunch cookbook in fall, dinner cookbook in fall, night-time snack cookbook in fall, breakfast cookbook in winter, lunch cookbook in winter, dinner cookbook in winter, and night-time snack cookbook in winter. Each of the sixteen sub-items corresponds to one or more cookbooks.

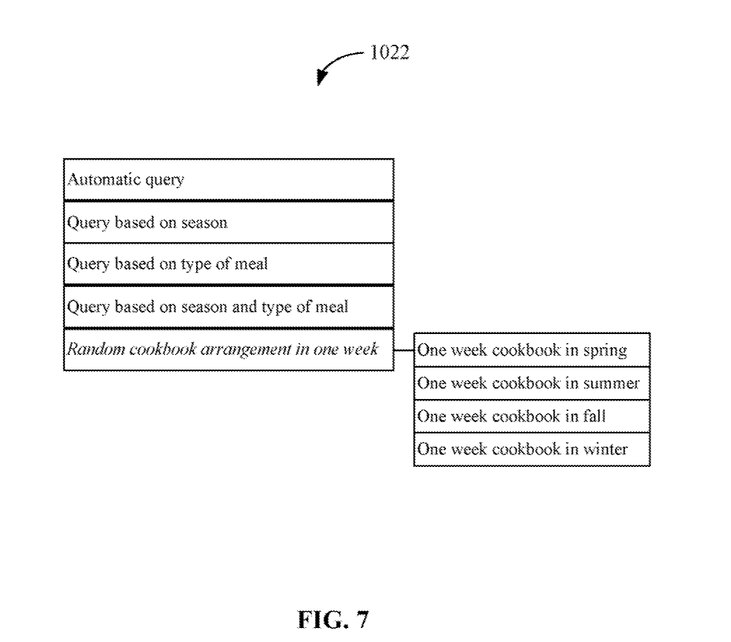

Referring to FIG. 7, the item of random cookbook arrangement in one week corresponds to a fourth sub-menu which includes four sub-items, such as one week cookbook in spring, one week cookbook in summer, one week cookbook in fall, and one week cookbook in winter. Each of the four sub-items corresponds to one or more cookbooks.

In another embodiment, the interface defining module 20 defines the cookbook query interface which includes more cookbook query items based on season and time of day.

The control module 40 performs a cookbook query function in response to a first input signal from the input unit 11 and controls the display unit 13 to display the first menu as shown in FIGS. 4-7. The acquiring module 30 selects a cookbook query item in the first menu in response to a second input signal from the input unit 11. The determining module 50 determines whether the acquiring module 30 has acquired the current date and time from the clock unit 10. If the acquiring module 30 has acquired the current date and time from the clock unit 10, that is, the item of automatic query in the first menu is selected in response to the second input signal, and if the acquiring module 30 does not acquire the current date and time from the clock unit 10, that is, when one item except for the automatic query in the first menu is selected in response to the second input signal.

When the determining module 50 determines that the current date and time from the clock unit 10 have been selected, the determining module 50 further determines the current season and the type of meal according to the current date and time from the table 162, the read module 60 reads cookbooks from the electronic cookbook database according to the current season and the type of meal and acquires recipes from the read cookbooks, and the display unit 13 displays the recipes. For example, if the current date and time are at 12:00 noon on Jul. 10 2011, the determining module 50 determines the current season is summer and the current type of meal is lunch, from the table 162, and the read module 60 reads fourteen cookbooks about lunch in summer from the electronic cookbook database and acquires recipes from the fourteen cookbooks. Therefore, the user can very conveniently obtain information for a well-balanced diet from the recipes.

If the determining module 50 determines that the current date and time from the clock unit 10 are not selected, the control module 40 controls the display unit 13 to display the second menu in response to the second input signal and the acquiring module 20 selects a cookbook item in the second menu in response to a third input signal from the input unit 11, the read module 60 reads cookbooks from the electronic cookbook database and acquires recipes from the read cookbooks, and the display unit 13 displays the recipes. For example, if the item of query based on season is selected in response to the second input signal and the cookbook item of cookbook in winter is selected in response to the third input signal, the read module 60 reads say fifty cookbooks about winter-time meals from the electronic cookbook database and acquires corresponding recipes. Therefore, the user can satisfy all his/her needs from the recipes.

The electronic device 1 provides a number of electronic cookbooks, the user of the device 1 can search cookbooks according to the user' needs and the device 1 can quickly find out the recipes for the current date and time from the searched cookbooks, therefore, the device 1 makes sure that the user gets information as to a well-balanced diet every day and the favorite food of the user can be selected at the same time.

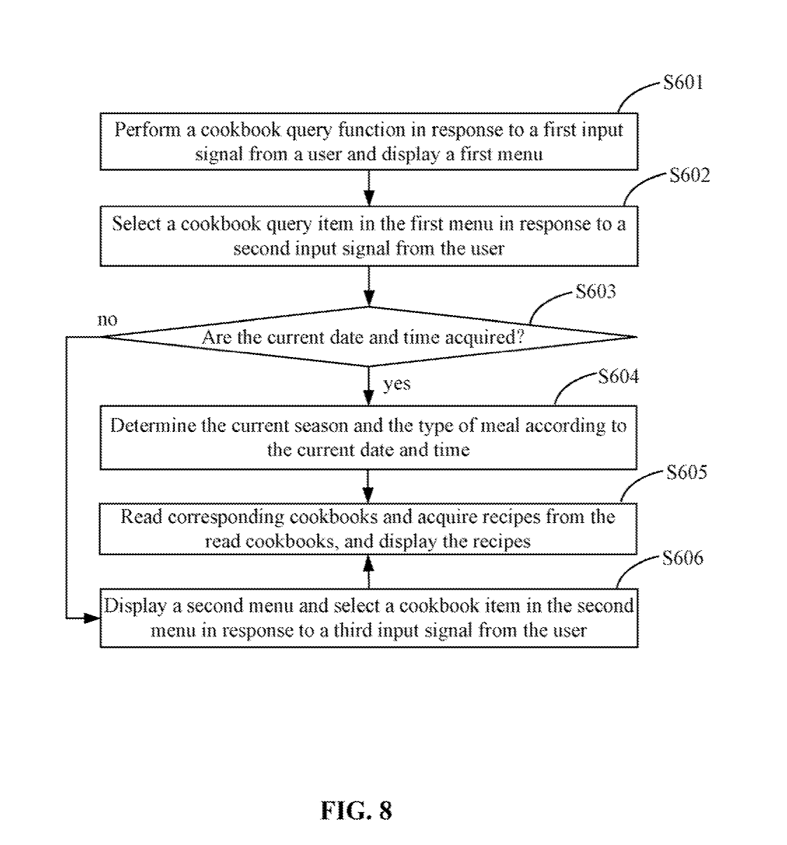

FIG. 8 is a flowchart of a method of selecting cookbook information, according to an exemplary embodiment. In step S601, the control module 40 performs the cookbook query function in response to the first input signal from the input unit 11 and controls the display unit 13 to display the first menu. In step S602, the acquiring module 30 selects a cookbook query item in the first menu in response to the second input signal from the input unit 11. In step S603, the determining module 50 determines whether the current date and time from the clock unit 10 have been selected. If yes, in step S604, the acquiring module 30 acquires the current date and time from the clock unit 10, the determining module 50 determines the current season and the type of meal according to the current date and time from the table 162.

If the current date and time from the clock unit 10 are not selected, in step S606, the control module 40 controls the display unit 13 to display the second menu and the acquiring module 20 selects a cookbook item in the second menu in response to a third input signal from the input unit 11. In step S605, when the current season and the type of meal are determined or the cookbook item in the second menu is selected, the read module 60 reads cookbooks from the electronic cookbook database and acquires recipes from the read cookbooks, and the display unit 13 displays the appropriate recipes.

Although the present disclosure has been specifically described on the basis of the exemplary embodiment thereof, the disclosure is not to be construed as being limited thereto. Various changes or modifications may be made to the embodiment without departing from the scope and spirit of the disclosure.

1. An electronic device for selecting recipes from cookbooks, comprising:
a storage unit for storing a plurality of electronic cookbooks, wherein each cookbook is marked with a timestamp and comprises a recipe;
a processing unit, for defining a number of cookbook query items which comprises an automatic query, when the automatic query is selected, acquiring current date and time, determining cookbooks from the storage unit according to the timestamp of each cookbook and the current date and time, and acquiring recipes from the determined cookbooks; and
a display unit for displaying the acquired recipes.

2. The electronic device as recited in claim 1, wherein the storage unit further stores a table which records time information, when the processing unit acquires the current date and time, the processing unit compares the current date and time with the table to obtain current timestamp.

3. The electronic device as recited in claim 2, wherein the table records relationships among seasons, months, types of meal, and times, and the timestamp of each cookbook denotes an appropriate season or appropriateness for several seasons and a suitable type or suitability for several types of meals.

4. The electronic device as recited in claim 3, wherein the electronic device defines a cookbook query interface which comprises a first menu, the first menu comprises five items which are the automatic query and several selection queries which comprises query based on season, query based on type of meal, query based on season and type of meal, and random cookbook arrangement in one week, when the electronic device performs the cookbook query function, the display unit displays the cookbook query interface.

5. The electronic device as recited in claim 4, wherein the processing unit comprises an acquiring module, a control module, a determining module, and a read module, the acquiring module is for selecting a cookbook query item in the first menu in response to user inputs, the determining module is for determining whether the current date and time have been selected, if the acquiring module has acquired the current date and time, the determining module determines the current season and the type of meal according to the current date and time from the table, if the current date and time are not selected, the control module controls the display unit to display a second menu associated with the several selection queries and the acquiring module selects a cookbook item in the second menu in response to user inputs, when the current season and the type of meal are determined or the cookbook item in the second menu is selected, the read module reads corresponding cookbooks and recipes to the display unit.

6. A method for selecting recipes from cookbooks by an electronic device, wherein the electronic device stores a plurality of electronic cookbooks, each cookbook is marked with a timestamp and comprises a recipe, and the electronic device defines a number of cookbook query items which comprises an automatic query, the method comprising:
when the automatic query is selected, acquiring current date and time;
determining stored cookbooks according to the timestamp of each cookbook and the current date and time;
acquiring recipes from the determined cookbooks; and
displaying the acquired recipes.

7. The method as recited in claim 6, wherein the electronic device further stores a table which records time information, the method comprising:
when acquiring the current date and time, comparing the current date and time with the table to obtain current timestamp.

8. The method as recited in claim 7, wherein the table records relationships among seasons, months, types of meal, and times, and the timestamp of each cookbook denotes an appropriate season or appropriateness for several seasons and a suitable type or suitability for several types of meals.

9. The method as recited in claim 8, wherein the electronic device defines a cookbook query interface which comprises a first menu, the first menu comprises five items which are the automatic query and several selection queries which comprises query based on season, query based on type of meal, query based on season and type of meal, and random cookbook arrangement in one week, when the electronic device performs the cookbook query function, the cookbook query interface is displayed.

10. The method as recited in claim 9, further comprising:
selecting a cookbook query item in the first menu in response to user inputs;
determining whether the current date and time is selected;
if the current date and time are selected, determining the current season and the type of meal according to the current date and time from the table;
if the current date and time are not selected, displaying a second menu associated with the several selection queries and selecting a cookbook item in the second menu in response to user inputs; and
when the current season and the type of meal are determined or the cookbook item in the second menu is selected, reading corresponding cookbooks and recipes to display.
